(19) United States
(12) Patent Application Publication
(10) Pub. No.: US 2008/0236442 A1
(43) Pub. Date: Oct. 2, 2008

(54) Chalk line device, waterproof chalk composition, and method

(75) Inventors: James Spaulding, Bristol, CT (US); Robert Scillia, West Hartford, CT (US)

Correspondence Address: PILLSBURY WINTHROP SHAW PITTMAN, LLP, P.O. BOX 10500, MCLEAN, VA, 22102, US

(73) Assignee: The Stanley Works, New Britain, CT (US)

(21) Appl. No.: 11/727,269

(22) Filed: Mar. 26, 2007

(51) Int. Cl. C09D 5/00; C09D 13/00; B44D 3/38

(52) U.S. Cl. 106/31.01; 106/31.09; 33/414

(57) ABSTRACT

A waterproof chalk composition including silicone oil, powdered chalk, and optional colorants, suitable for applying to a chalk line of a chalk line device, is provided. Methods of making and using the waterproof chalk composition using silicone oil, powdered chalk, and colorants, are provided. The waterproof chalk composition provided herein can be used or packaged immediately after preparation, and does not require a drying step to evaporate solvents. The waterproof chalk composition provided herein does not contain environmentally unfriendly components such as solvents.

### BACKGROUND OF THE INVENTION

1. Field of the Invention

The present invention pertains to chalk line devices and to chalk compositions for use with chalk line devices.

2. Discussion of Related Art

Chalk line devices are widely employed to mark straight lines on surfaces on a workpiece or work place. Generally, the chalk line device includes a housing or casing which defines a reservoir for storing chalk and stores an extendable line about a spool that is driven by a crank outside of the housing. Chalk line devices use a finely powdered chalk which is applied to the chalk line within the housing. The powdered chalk may be colored brightly so as to allow the user to distinguish a mark line from a surface color of the workpiece.

To mark a straight line using a chalk line device, a colored chalk composition is applied to the chalk line, generally from a colored chalk composition in reservoir of the chalk line device, and the chalk line with the colored chalk composition is pulled taut along the desired straight line, and the taut chalk line is “snapped” to leave a straight line of chalk powder on the surface.

Conventional chalk line devices do not perform optimally in wet weather conditions.

Previously disclosed waterproof chalk compositions for use with chalk line devices have certain disadvantages. US 2005/0076520 discloses treating powdered material for use with a snap line by spraying an aerosolized silicone-based waterproofing material into a container with the powdered material. The waterproofing materials contain solvents and other additives that must be removed after being mixed with the chalk by a drying step. This drying step requires time and slows down the manufacturing process. In addition, the solvents and/or other additives can be environmentally unfriendly.

### BRIEF SUMMARY OF THE INVENTION

The present disclosure provides a waterproof chalk composition including silicone oil, powdered chalk, and optionally at least one colorant, suitable for applying to a chalk line of a chalk line device, and methods of making and using the waterproof chalk composition.

The waterproof chalk composition can include silicone oil in an amount of about 1% by weight to about 15% by weight of the total composition, and the remainder, or balance, or the composition includes a mixture of chalk and optionally, at least one colorant. The waterproof chalk composition can include silicone oil in an amount of about 2% by weight to about 13% by weight, about 3% by weight to about 11% by weight, about 4% by weight to about 9% by weight, about 5% by weight to about 7% by weight, or about 6% by weight of the total composition.

The balance of the waterproof chalk composition (excluding the silicone oil) can contain chalk and optionally, at least one colorant. The waterproof chalk composition can include chalk in an amount of about 100% by weight of the balance. The waterproof chalk composition can include chalk in an amount of about 50% by weight to about 99% by weight of the balance, about 60% by weight to about 95% by weight of the balance, about 70% by weight to about 90% by weight of the balance, or about 80% by weight of the balance. The waterproof chalk composition can include silicone oil in an amount of about 6% by weight of the total composition, and chalk in an amount of about 80% by weight of the balance. The waterproof chalk composition can include silicone oil in an amount of about 6% by weight of the total composition, chalk in an amount of about 80% by weight of the balance, and colorant in an amount of about 20% by weight of the balance.

A waterproof chalk composition is provided that includes silicone oil, powdered chalk, and optionally at least one colorant, and is devoid of a solvent.

A chalk line device is provided containing the waterproof chalk composition in the chalk reservoir of the device. A chalk line device is provided, including a housing having a chalk line port and defining an interior space including a chalk reservoir into which chalk can be placed, a waterproof chalk composition disposed within the chalk reservoir, the chalk composition including silicone oil in an amount of about 1% to about 15% by weight of the total composition, the balance of the composition including a mixture of chalk and optionally at least one colorant, a chalk line support mounted in the interior space in the housing, a chalk line operatively connected with the chalk line support and extending through the chalk line port, and a retracting mechanism mounted to the housing and being operable to retract the chalk line into the housing and allow the chalk line to be extended from the housing through the chalk line port.

These and other aspects of the invention will become apparent when considered with the detailed description and drawings.

### BRIEF DESCRIPTION OF THE DRAWINGS

In the accompanying drawings:

FIG. 1 is a front elevational view of a chalk line device according to an embodiment of the present invention;

FIG. 2 is a side view of a chalk line device of FIG. 1 according to an embodiment of the present invention;

FIG. 3 is a front elevational view of a chalk line device according to another embodiment of the present invention;

FIG. 4 is a side view of a chalk line device of FIG. 3 according to an embodiment of the present invention; and

FIG. 5 is a cross-sectional view of a chalk line device according to an embodiment of the present invention.

### DETAILED DESCRIPTION OF PREFERRED EMBODIMENTS OF THE INVENTION

The present disclosure provides a waterproof chalk composition including silicone oil, powdered chalk, and optionally at least one colorant, suitable for applying to a chalk line of a chalk line device, and methods of making and using the waterproof chalk composition.

In accordance with one aspect of the invention, the waterproof chalk composition includes silicone oil in an amount of about 1% to about 15% by weight of the total composition, and the balance of the composition includes a mixture of chalk and optionally at least one colorant. The waterproof chalk composition can comprise silicone oil in an amount of about 2% to about 13% by weight, or about 3% to about 1% by weight, or about 4% to about 9% by weight, or about 5% to about 7% by weight of the total composition. In one embodiment, the waterproof chalk composition includes silicone oil in an amount of about 6% by weight of the total composition.

In accordance with one aspect of the invention, the balance of the waterproof chalk composition includes a mixture of chalk and optionally at least one colorant. In one embodiment, the waterproof chalk composition containing silicone oil includes chalk in an amount of up to about 100% by weight of the balance. The waterproof chalk composition containing silicone oil can include chalk in an amount of about 50% to about 99% by weight of the balance, or about 60% to about 95% by weight of the balance, or about 70% to about 90% by weight of the balance. In one embodiment, the waterproof chalk composition containing silicone oil contains chalk in an amount of about 80% by weight of the balance. In one embodiment, the waterproof chalk composition includes silicone oil in an amount of about 6% by weight, chalk in an amount of about 80% by weight of the balance, and at least one colorant. In one embodiment, the waterproof chalk composition includes silicone oil and powdered chalk, and one colorant. In one embodiment, the waterproof chalk composition includes silicone oil and powdered chalk, and a plurality of colorants. In one embodiment, the waterproof chalk composition includes silicone oil and powdered chalk, and does not contain a colorant. In one embodiment, the waterproof chalk composition includes silicone oil and colored powdered chalk, and no colorant is added to the composition.

In accordance with one aspect of the invention, a method is provided for preparing a waterproof chalk composition including silicone oil, powdered chalk, and optionally at least one colorant, suitable for use with a chalk line device. The method includes providing silicone oil in amounts from about 1% to about 15% by weight of the total composition, the balance of the composition including chalk in an amount from about 100% to about 50% by weight, and optionally, at least one colorant, and mixing the silicone oil, chalk, and optional colorant. In one embodiment, the method includes providing silicone oil in an amount of about 6% by weight, chalk in an amount of about 80% by weight of the balance, and at least one colorant. In another embodiment, the method includes providing silicone oil in an amount of about 6% by weight, chalk in an amount of about 80% by weight of the balance, and colorant in an amount of about 20% by weight of the balance. In one embodiment, colorant is added to the chalk and mixed, and silicone oil is added to the mixture of chalk and colorant. In another embodiment, colorant and silicone are added to the chalk at the same time. In another embodiment, chalk is added to the silicone oil and colorant is subsequently added. In one embodiment, no colorant is added.

The waterproof chalk composition of the present invention can be used or packaged immediately after preparation. The compositions and methods of the present invention do not require a drying step to evaporate solvents. The compositions and methods do not contain environmentally unfriendly components such as evaporated solvents and/or additives, e.g., chemicals involved in aerosol delivery of waterproofing components.

In one embodiment, silicone oil, chalk, and optional colorant are mixed by a rotating drum, to facilitate complete mixing and to produce a desired amount of uniformly mixed waterproof chalk composition. The waterproof chalk composition of the present invention can be used immediately after mixing is complete. In one embodiment, the waterproof chalk composition is packaged for sale and distribution immediately after mixing. In another embodiment, the waterproof chalk composition is introduced into chalk reservoirs of chalk line devices immediately after mixing.

Chalk suitable for use in the present invention can be composed of calcium carbonate, although the chalk may be of different types and/or contain other components such as minor impurities arising from deposition or mining. Chalk preparations, in some embodiments, may also include additional ingredients including, but not limited to, binding agents, drying agents, or inert ingredients.

Colorants for use in the present invention may include any colorant suitable for mixing with chalk and silicone oil to prepare a waterproof chalk composition. Colorants may be selected on the basis of desired properties for a given application including hue (color), stability, durability, and penetration. Generally, any colorant known to be suitable for coloring chalk for use in a chalk line device, is suitable for use in the present invention. Suitable colorants may be mineral ores, naturally occurring colored pigments, or synthetic dyes including, but not limited to, iron oxides (e.g., hematite), ultramarine, malachite, inks, or synthetic pigments. In a particular embodiment, synthetic iron oxides in yellow, red, black or brown pigment formulations may be used. It is understood that the term “colorant” as used herein includes colorant preparations that contain other ingredients in addition to the material being used to provide color. For example, iron oxide-containing colorant preparations may include calcium carbonate and silicon dioxide. It is understood that colorant formulations can be added to the mixture in an amount ranging from about 10% to about 30% by weight, for example, in an amount of about 20% by weight. It is understood that more than one colorant may be used in the compositions and methods of the present invention.

In one embodiment, no solvent (neither volatile solvent, nor solid remnant of a solvent) is contained by the waterproof chalk composition. A solvent free colorant is used. Thus, drying time is eliminated, and an environmentally friendly product is provided.

In another embodiment, the colorant or dye may have solvent remnants (solids) remaining from the manufacturing process of the colorant or dye, but it would be received for mixing at the manufacturing site with no volatile solvents, and no volatile solvents would be involved in the mixing of the colorant with the chalk or with the silicone.

The term “silicone oil” is used herein to refer generally to liquid silicones, more accurately called polymerized siloxanes or polysiloxanes, which are inorganic-organic polymers with the chemical formula [R₂SiO]ₙ, where R=organic groups such as methyl, ethyl, and phenyl. The polymers have a backbone of silicon and oxygen molecules ( . . . —Si—O—Si—O—Si—O— . . . ) with the organic side groups attached to the silicon atoms. In some cases organic side groups can be used to link two or more of these —Si—O— backbones together. By varying the —Si—O— chain lengths, side groups, and crosslinking, silicones can be synthesized with a wide variety of properties and compositions.

Silicone oils suitable for use in the present invention include, but are not limited to, compounds known as polydimethylsiloxane (PDMS), dimethylpolysiloxane hydrolysate, dimethyl phenylmethyl siloxane, alpha-methyl-omega-methoxypolydimethylsiloxane, polyoxy(dimethylsilylene) alpha-(trimethylsilyl)-omega-hydroxy, poly[oxy(dimethylsilylene)]alpha-[trimethylsilyl]-omega-[(trimethylsilyl)oxy], dimethyl; alpha-(Trimethylsilyl) poly[oxy(dimethylsilylene)]-omega-methyl, including PDMS with specific end groups, e.g., PDMS methyl end-blocked. In one embodiment, a hydrogen-bearing silicone oil emulsion known as “202 hydro-silicone oil” available from Goalmac International Ltd., Nanjing China, is used in the compositions and methods of the present invention.

In accordance with one embodiment, silicone oil can be mixed with chalk and optional colorant in an amount ranging from about 1% by weight to about 15% by weight of the total composition, with the remainder, or balance, of the composition formed predominantly from chalk powder and optionally at least one colorant. The waterproof chalk composition can comprise silicone oil in an amount of about 2% by weight to about 13% by weight, or about 3% by weight to about 11% by weight, or about 4% by weight to about 9% by weight, or about 5% by weight to about 7% by weight, or about 6% by weight of the total composition. The balance of the composition can contain chalk in an amount from about 100% to about 50% by weight, and optionally, at least one colorant. In one embodiment, the method includes providing silicone oil in an amount of about 6% by weight of the total composition, chalk in an amount of about 80% by weight of the balance, and at least one colorant. In another embodiment, the method includes providing silicone oil in an amount of about 6% by weight of the total composition, chalk in an amount of about 80% by weight of the balance, and colorant in an amount of about 20% by weight of the balance. The waterproof chalk composition as disclosed herein is devoid of a solvent additive.

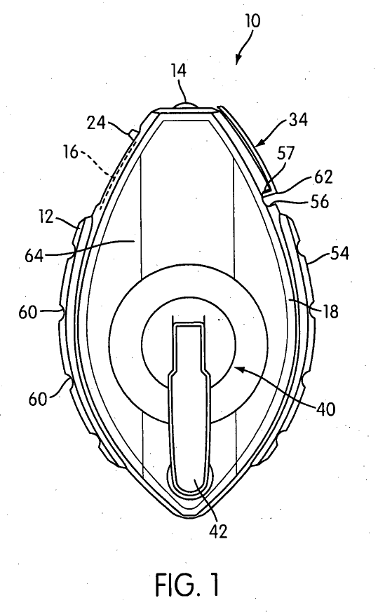

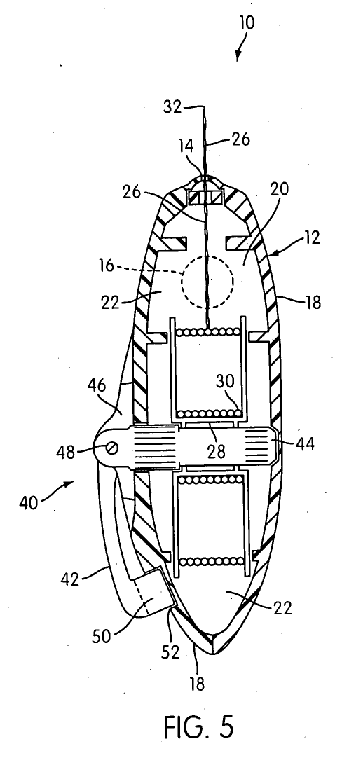

A waterproof chalk composition of the invention can be used with a typical chalk line device as disclosed in U.S. Pat. No. 6,915,587 (“the '587 patent”), hereby incorporated by reference, and as shown in FIGS. 1-5. In one embodiment, the waterproof chalk composition of the invention is introduced into the chalk reservoir 22 (FIG. 5). In one embodiment, the translucent window 64, 65 allows the use to check the level of waterproof chalk composition remaining in the reservoir 22.

A chalk line device 10 is shown that includes a housing 12 having a chalk line port 14 and a chalk port 16. The housing 12 defines an exterior surface 18 and an interior space 20. The interior space 20 includes a chalk reservoir 22 in communication with the chalk port 16.

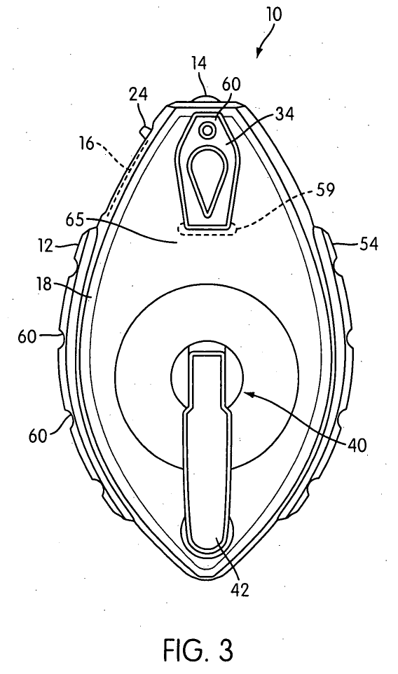

A movable door 24 (shown in FIGS. 1 and 3) is secured to the housing 12 over the chalk port 16 to selectively open and close the chalk port 16. Any suitable closure mechanism may be used including a hinged door, a sliding door or even a self-sealing access port. As seen in FIG. 5, a chalk line 26 is spooled around a chalk line support 28. The chalk line support 28 is rotatably mounted in the interior space 20 in the housing 12.

The chalk line 26 has one end 30 secured to the chalk line support 28 within the housing 12 and another end 32 provided with a hook 34 disposed outside of the housing 12. The chalk line 26 extends through the chalk line port 14.

The chalk line device 10 further includes a retracting mechanism 40 which is mounted to the housing 12. The retracting mechanism comprises a handle 42, a crank shaft 44 and an integral hub 46.

The retracting mechanism 40 is connected to the chalk line support 28 via the crank shaft 44 and allows the chalk line 26 to be freely extended from the housing 12 through the chalk line port 14 when the user pulls the hook 34 attached to end 32 of chalk line 26. The retracting mechanism 40 also allows selective retraction of the chalk line 26 into the housing when the user rewinds the chalk line by rotating the handle 42. Of course any known retracting and spooling mechanisms could be used.

The handle 42 is connected to hub 46 via pivot pin 48. The handle 42 can easily be moved from a storing position through an arc of about 180° to assume a cranking position as is known. The handle 42 has a knob 50 rotatably mounted on handle 42 to allow the user to rotate the handle 42 while being able to maintain grip on the knob 50. This feature facilitates rewinding of the chalk line. In addition, the knob 50 also serves as a rotating-stop for halting the rotation of the hub 46 and crank shaft 44 when the handle 42 is moved to a stored position. In the stored position, the knob 50 is inserted into a groove 52 provided in the exterior surface 18 of housing 12. In this way, the groove 52 serves as a rotating-stop and also renders the arm 42 more compact with the housing 12 for storage and/or handling.

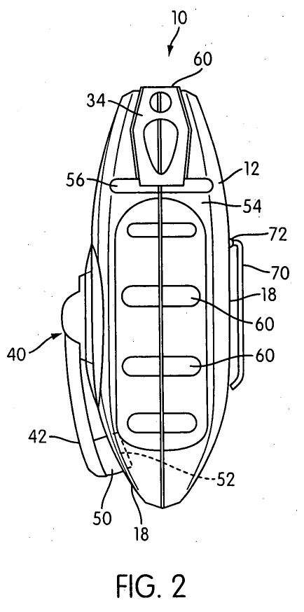

The exterior surface 18 of housing 12 also includes a side wall 54 with a depression 56 formed therein that is shaped to receive the hook 34 for storage, as seen in FIGS. 1-2. The depression 56 is formed as an elongated slot to allow easy insertion of the hook 34 as described below. The depression 56 is positioned adjacent to the chalk line port 14 so that when the line 26 is fully retracted in the housing 12, only the hook 34 remains on the exterior to prevent chalk from the line 26 from inadvertently soiling surfaces it may contact. So the depression 56 is preferably spaced from the port 14 about the length of the hook 34.

The depression 56 has an edge 57 (shown in FIG. 1) that allows the hook 62 to securely engage to prevent accidental removal. The edge 57 extends that an angle of about 90° or less from the surface 54 of housing 12 to form an acute ledge for the hook 34 to engage. The depression 56 has a mouth that is flush with the side wall 54.

The hook 34 has a body with a line attachment device 60 on one end and a finger 62 extending outwardly from the other end. The finger 62 engages the depression 56 during storage, as shown in FIGS. 1-3. The shape of the hook 34 can be designed such that the hook 34 can mate with a surface of side wall 54. For example, the shape of the hook can be curved to follow the curvature of side wall 54, as illustrated in FIG. 1. Of course, any known end piece for a chalk line can be used, including various shapes and configurations.

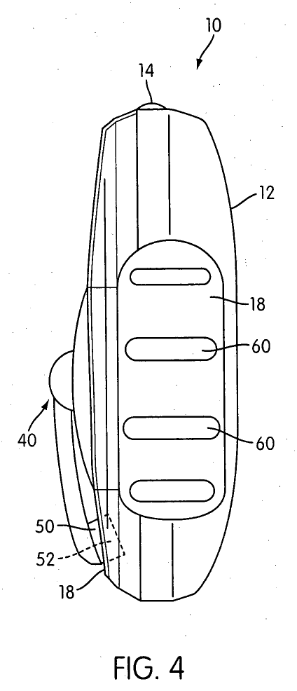

The movable chalk door 24 can be mounted on any surface of the housing 12. Similarly, the depression 56 can be formed on any surface of housing. For example, in the embodiment shown in FIGS. 1 and 2, the movable chalk door 24 is mounted to one side wall of the housing 12 and the depression is located on a different side of the housing 12. As seen in FIG. 2, the chalk door 24 is mounted on one side wall of the housing 12 and the depression 56 is located on a side wall situated on an opposite side of the housing 12. Whereas, in the embodiment shown in FIGS. 3 and 4, the chalk door 24 is mounted, for example, on one side wall of the housing and the depression 59 is located on a side wall that extends at an angle to the side wall with the chalk door 24. Alternatively, the chalk door 24 can be mounted on one side wall of the housing 12 and the depression 56 can be located on the same side wall, below the door 24 to cover the door 24 or at an end spaced apart from the door 24.

The side wall(s) 54 of housing 12 can be provided with a plurality of grip formations 60. As seen in FIGS. 2 and 4, the formations 60 are formed on the side wall to provide the user with a less slippery surface to grip and handle the chalk line device 10. Alternatively, the side wall(s) 54 of housing 12 can be provided with a plurality of ridges. In this case also, the ridges provide the user with a less slippery surface for better grip. However, any textured surface would be suitable for providing enhanced grip.

The housing 12 also includes a mechanism for determining the level of the chalk in the reservoir 22. As seen in FIGS. 1 and 3, the chalk line device 10 has a translucent window 64 (shown in FIG. 1) or window 65 (shown in FIG. 3). The window 64, 65 forms at least a portion of a wall of the chalk reservoir 22. The window 64, shown in FIG. 1, is a strip of translucent material covering one or more walls of the housing 12 over an entire length of the housing. The translucent window 65 shown in FIG. 3 forms a substantial portion of one side of the housing 12 and extends the length of the housing 12. However, one can appreciate that the translucent window 64, 65 can be formed on any selected surface portion of the housing 12 and have any size or shape.

The translucent window 64, 65 allows the user to check the level of chalk remaining in the reservoir 22. In one embodiment, the window 64, 65 is provided with a scale to indicate the level of chalk quantity in the reservoir. In another embodiment, the window 64, 65 can include a scale with three lines with the words (low, medium and high) written, respectively, beside each line to indicate to the user the approximate level of quantity of chalk in the reservoir.

The housing 12 is preferably formed of plastic but may also be formed of metal or any other suitable material or combination of materials. The window 64, 65 is preferably formed of a translucent plastic, but may also be formed of glass or other translucent material. The window 64, 65 can be transparent, clear or colored, as long as a user can view the interior of reservoir 22. The window 64, 65 can be integrally formed with the housing 12. The housing 12 may be formed as one piece or multiple pieces. In this case, the housing 12 can be over-molded with opaque material while leaving an area for the window 64, 65. For example, the housing 12 can be over-molded with a relatively soft material such as a soft plastic or rubber to protect the housing 12 from breaking in case the device 10 is dropped on a hard surface.

As stated above, the depression which receives the hook 34 for storage can be formed on any surface of housing 12. For example, as shown in FIG. 3, the depression 59 is formed on window 64. Similarly to the embodiment shown in FIGS. 1 and 2, the depression 59 is formed as an elongated slot to allow easy insertion of the hook 34. The hook 34 remains on the exterior to prevent chalk from the line 26 from inadvertently soiling surfaces it may contact. So the depression 59 is preferably spaced from the port 14 about the length of the hook 34.

The depression 59 has an edge that allows the hook 62 to securely engage to prevent accidental removal. Similarly to the embodiment shown in FIGS. 1 and 2, the edge extends at an angle of about 90° or less from the surface 54 of housing 12 to form an acute ledge for the hook 34 to engage. The depression 59 has a mouth that is flush with the surface of window 65.

As seen in FIG. 4, the depression may be enlarged to extend from the edge so as to receive the entire hook 34 rather than just the finger 62. In this way, the hook 34 lies flush in the exterior surface 18 of the housing 12, as seen in FIG. 4. Of course, a depression similar to that shown in FIG. 1 could also be formed in the window 65 as well.

The chalk line device further optionally includes a clip 70 that is pivotally attached to a wall of housing 12 at point 72. The clip 70 can be spring biased at the point 72 to allow biasing the clip 70 toward a wall of the housing 12. The clip 70 can be used, for example, to hold the chalk line device 10 on a support. For instance, the clip 70 can be slid in a belt or on a pocket rim of a user to allow easy retrieval and storage.

Although the hook 34 is shown in the Figures having a certain shape or form, it is also within the scope of the present invention to have various shapes or form and make the hook from any material, such as but not limited to metal and plastic. The many features and advantages of the present invention are apparent from the detailed specification and thus, it is intended by the appended claims to cover all such features and advantages of the described apparatus which follow the true spirit and scope of the invention.

It should be appreciated that the description of the chalk line device illustrated in FIGS. 1-5 correspond almost identically to that disclosed by the '587 patent, and is provided as just one example of the type of chalk line device that can be used with the waterproof chalk composition disclosed herein. It should be appreciated that any chalk line device that incorporates a line that is to receive chalk powder can be used in conjunction with the waterproof chalk composition disclosed herein.

Furthermore, since numerous modifications and changes will readily occur to those of skill in the art, it is not desired to limit the invention to the exact construction and operation described herein. Accordingly, all suitable modifications and equivalents should be considered as falling within the spirit and scope of the invention.

What is claimed:

1. A waterproof chalk composition for applying to a chalk line of a chalk line device comprising, silicone oil in an amount of about 1% by weight to about 15% by weight of the total composition, the composition further comprising a mixture of chalk and optionally at least one colorant.

2. The composition of claim 1, wherein the composition is devoid of a solvent.

3. The composition of claim 1, comprising silicone oil in an amount of about 3% by weight to about 11% by weight.

4. The composition of claim 1, comprising silicone oil in an amount of about 4% by weight to about 9% by weight.

5. The composition of claim 1, comprising silicone oil in an amount of about 5% by weight to about 7% by weight.

6. The composition of claim 1, comprising silicone oil in an amount of about 6% by weight.

7. The composition of claim 1, comprising chalk in an amount of about 100% by weight of the balance.

8. The composition of claim 1, comprising chalk in an amount of about 50% by weight to about 99% by weight of the balance.

9. The composition of claim 1, comprising chalk in an amount of about 60% by weight to about 95% by weight of the balance.

10. The composition of claim 1, comprising chalk in an amount of about 70% by weight to about 90% by weight of the balance.

11. The composition of claim 1, comprising chalk in an amount of about 80% by weight of the balance.

12. The composition of claim 11, further comprising silicone oil in an amount of about 6% by weight of the total composition.

13. The composition of claim 4, wherein the composition is devoid of a solvent.

14. A chalk line device, comprising:
a housing having a chalk line port and defining an interior space including a chalk reservoir into which chalk can be placed,
a water proof chalk composition disposed within the chalk reservoir, the chalk composition comprising silicone oil in an amount of about 1% to about 15% by weight of the total composition, the composition further comprising a mixture of chalk and at least one colorant.
a chalk line support mounted in the interior space in the housing;
a chalk line operatively connected with the chalk line support and extending through the chalk line port; and
a retracting mechanism mounted to the housing and being operable to retract the chalk line into the housing and allow the chalk line to be extended from the housing through the chalk line port.

15. A chalk line device according to claim 14, wherein the composition is devoid of a solvent.

16. A method for manufacturing a waterproof chalk composition, comprising:
providing a chalk powder;
mixing a colorant with the chalk powder;
mixing silicone oil in an amount of about 1% to about 15% by weight of the total composition with the chalk and colorant; and
after mixing the silicone oil with the chalk and colorant, packaging the mixture without an intermediate drying step.
